(19) United States
(12) Patent Application Publication
(10) Pub. No.: US 2008/0268008 A1
(43) Pub. Date: Oct. 30, 2008

(54) Methods to Control Termites

(76) Inventors: James Edward King, Carmel, IN (US); Paul Allen Neese, Westfield, IN (US); Ronald Sbragia, Placerville, CA (US); Naim Akmal, Zionsville, IN (US); Dennis George Wujek, Zionsville, IN (US)

Correspondence Address: Dow AgroSciences, 9330 Zionsville Road, Indianapolis, IN, 46268, US

(21) Appl. No.: 11/629,064

(22) PCT Filed: Jun. 9, 2005
(86) PCT No.: PCT/US2005/020428

§ 371 Date: Dec. 8, 2006

Related U.S. Application Data
(60) Provisional application No. 60/578,235, filed on Jun. 9, 2004.

(51) Int. Cl. A01N 25/00; A01P 7/04

(52) U.S. Cl. 424/405

(57) ABSTRACT

This invention is related to the field of methods useful to control termites, especially, subterranean termites.

This invention is related to the field of methods to control termites.

The prevention and control of termites accounts for 25 percent of all pest control industry revenues in the United States. This is because termites cause billions of dollars in damage each year throughout the world. In the U.S. alone it is estimated that termites will cause more than two billion dollars of damage in 2004. Consequently, new methods are constantly being research to help control this growing menace.

In general, the methods of this invention comprise contacting a termite bait with a mixture comprising water where said mixture is buffered to a pH of 1 to 6, with certain provisos described herein.

As used herein the phrase “HC Mixture” means a mixture meant for human consumption resulting from mixing only the following ingredients together: water; sucrose; glucose; fructose; citric acid; natural flavors; NaCl; sodium citrate; monopotassium phosphate; ester gum; and coloring, having a pH from 3 to 4.

As used herein the phrase “SSPB Mixture” means a mixture meant for human consumption having a pH from 3 to 4 and consisting essentially of (1) a total of 11.9 to 16.1 grams sugar, where said sugar consists of glucose, sucrose, and fructose; (2) 93.5 to 126.5 milligrams of sodium; and (3) 25.5 to 34.5 milligrams of potassium; per 240 milliliters water.

As used herein the phrase “SSPI Mixture” means a mixture meant for human consumption having a pH from 3 to 4 and consisting essentially of (1) a total of 12.6 to 15.4 grams sugar, where said sugar consists of glucose, sucrose, and fructose; (2) 99 to 121 milligrams of sodium; and (3) 27 to 33 milligrams of potassium; per 240 milliliters water.

As used herein the phrase “SSPN Mixture” means a mixture meant for human consumption having a pH from 3 to 4 and consisting essentially of (1) a total of 13.3 to 14.7 grams sugar, where said sugar consists of glucose, sucrose, and fructose; (2) 104.5 to 115.5 milligrams of sodium; and (3) 28.5 to 31.5 milligrams of potassium; per 240 milliliters water.

Termites can be controlled by the inventive methods herein, especially subterranean termites such as Reticulitermes spp. and Coptotermes spp. Suitable examples of termites that can be controlled are: Reticulitermes flavipes; Reticulitermes virginicus; Reticulitermes Hesperus; Heterotermes aureus; Coptotermes formosanus; Reticulitermes speratus; Reticulitermes grassei; Reticulitermes santonensis; Macrotermes gilvus; and Reticulitermes hageni.

Termite baiting technology is known in the art. Suitable examples are U.S. Pat. Nos. 4,868,215; 5,556,883; 5,406,744; 6,397,516; 5,285,688; 6,093,415; 6,058,646; 6,079,151; 5,886,221; 5,945,453; 5,811,461; 6,040,345; 5,815,090; 6,404,210; 6,016,625; 5,968,540; 6,100,805; 6,323,772; 6,423,730; 6,243,014; 6,255,959; 6,281,799; 6,304,185; 6,313,748; 6,373,391; 6,392,545; 6,515,591; 6,630,887. In general, when a termite bait is used, such a bait usually comprises cellulose, or some form thereof such as alpha cellulose, and an insecticide. The bait is then placed in a locus that is assessable to termites. The termites come in contact with the bait, eat a portion thereof and die from the ingestion of the insecticide. One of the better methods is to use a slow acting termiticide such that the termite can eat the bait and return to the colony and share the consumed bait throughout the termite colony. This allows the consumption of insecticide by other members of the colony.

Alpha cellulose is readily available. It can be purchased from a variety of sources. One particular source is International Fiber Corporation. It is particularly preferred if the alpha cellulose is in powdered form, however, it can be compacted into other forms, such as pellets and briquettes. Currently, briquettes are especially preferred.

Examples of suitable insecticides that may be used are:

(a) Pyrethroids, such as permethrin, cypemethrin, fenvalerate, esfenvalerate, deltamethrin, cyhalothrin, lambda-cyhalothrin, gamma-cyhalothrin, bifenthrin, fenpropathrin, cyfluthrin, tefluthrin, fish safe pyrethroids (for example ethofenprox), natural pyrethrin, tetramethrin, s-bioallethrin, fenfluthrin, prallethrin, 5-benzyl-3-furylmethyl-(E)-(IR,3S)-2,2-dimethyl-3-(2-oxothiolan-3-ylidenemethyl) cyclopropane carboxylate, or any of their insecticidally active isomers;

(b) Organophosphates, such as, methidathion, chlorpyrifos-methyl, profenofos, sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, chlorpyrifos-methyl, phosalone, terbufos, fensulfothion, fonofos, phorate, phoxim, pirimiphos-methyl, pirimiphos-ethyl, fenitrothion, fosthiazate or diazinon;

(c) Carbamates (including aryl carbamates), such as fenoxycarb, alanycarb, pirimicarb, triazamate, cloethocarb, carbofuran, furathiocarb, ethiofencarb, aldicarb, thiofurox, carbosulfan, bendiocarb, fenobucarb, propoxur, methomyl or oxamyl;

(d) Benzoyl ureas, such as lufenuron, novaluron, noviflumuron, teflubenzuron, diflubenzuron, triflumuron, hexaflumuron, flufenoxuron or chlorfluazuron;

(e) Organic tin compounds, such as cyhexatin, fenbutatin oxide or azocyclotin;

(f) Pyrazoles, such as tolfenpyrad, pyridaben, tebufenpyrad and fenpyroximate;

(g) Macrolides, such as avermectins or milbemycins, for example abamectin, emamectin benzoate, ivermectin, milbemycin, spinosad or azadirachtin;

(h) Hormones or pheromones;

(i) Organochlorine compounds such as endosulfan, benzene hexachloride, DDT, chlordane or dieldrin;

(j) Amidines, such as chlordimeform or amitraz;

(k) Chloronicotinyl compounds such as diofenolan, clothianidin, thiacloprid, imidacloprid, thiacloprid, acetamiprid, nitenpyram or thiamethoxam;

(l) Diacyihydrazines, such as halofenozide, tebufenozide, chromafenozide or methoxyfenozide;

(m) Diphenyl ethers, such as diofenolan or pyriproxifen;

(n) Indoxacarb;

(o) Chlorfenapyr;

(p) Pymetrozine;

(q) Diafenthiuron;

(r) Toxins of microbial origin such as B.acillus thuringiensis endo- or exotoxins;

(s) Phenylpyrazoles such as fipronil, vanilliprole, etiprole or acetoprole;

(t) Pyridalyl; or

(v) hydramethylnon

Examples of suitable insecticide synergists that may be used include piperonyl butoxide, sesamex, safroxan and dodecyl imidazole.

Specific examples of preferred insecticides are thiamethoxam, abamectin, emamectin benzoate, spinosad, chlorpyrifos, chlorpyrifos-methyl, profenofos, lufenuron, indoxacarb, lambda-cyhalothrin, pymetrozine, pirimicarb, methidathion, imidacloprid, acetamiprid, thiacloprid, fipronil, methoxyfenozide, chlorfenapyr, pyridaben, novaluron, noviflumuron, pyridalyl, propargite and piperonyl butoxide.

Mixtures of insecticides are also useful and many of the above can be synergistically used together.

In general the amount of insecticide to use is also not critical. Amounts from 0.0001 to 10 weight percent based on the weight of the bait can be used.

In this invention the bait is placed in the ground, perhaps inside another tube that allows access for termites, and prior to placing the bait in the ground or tube, or leaving it in the ground or tube, a buffered water mixture is contacted with the bait.

The buffered water mixture has a pH from 1 to 6. It is preferred when the buffered water mixture has a pH below 5, such as, from 1 to 5. It is also preferred, when the buffered water mixture has a pH below 4, such as, from 2 to 4.

The buffered water solution can also comprise a salt such as sodium chloride or potassium chloride. The amount can be from 0.001 to 20 weight percent of the buffered water mixture. However, currently, it is preferred to use 0.01 to 1 weight percent salt.

The buffered water solution can also comprise a sugar such as glucose, fructose, or sucrose. The amount can be from 1 to 20 weight percent of the buffered water mixture. However, currently, it is preferred to use 1 to 10 weight percent sugar. It is also currently preferred to use a mixture of sugars, such as a mixture of monosaccharides, a mixture of mono and disaccharides, or a mixture of disaccharides.

### EXAMPLES

These examples are provided to illustrate the invention. They are not to be used for limiting the scope of the invention.

### Example A

### Preparation of Termite Bait Composition

A termite bait composition (“TBC”) comprising laminated, textured cellulose and Noviflumuron (0.05 weight percent based on the weight of the TBC) was prepared as follows. An aqueous suspension of noviflumuron was diluted and then used as a coating mix in the gravure roll application of noviflumuron onto textured cellulose.

### Example One

This example employed a “one-way” paired choice test, with two different treatments on the TBC. All treatments were applied at 150 microliter volumes to each TBC. After the treatment, each TBC was dried for at least 24 hours prior to testing. Tests for each choice test were replicated 3-4 times and held for 7 days.

Mixture 1 was a pH 4 buffered water mixture prepared as follows. First, a solution of citric acid was made by mixing 1.92 grams citric acid per 100 mL of deionized water. Second, a solution of dibasic sodium phosphate was made by mixing 2.83 grams per 100 mL of deionized water. Third, 61.4 mL of the citric acid solution was mixed with 39.6 mL of the sodium phosphate solution. Fourth, the solution produced in step three and mixed with 100 mL of deionized water to form 200 mL of the pH 4 buffered water mixture. This mixture was applied to the TBC in a 2:1 weight ratio.

Mixture 2 was a pH 4 buffered water and salt mixture prepared as follows. To the pH 4 buffered water mixture sufficient sodium chloride and potassium chloride was added to give a pH 4 buffered water and salt mixture having 0.0125 weight percent sodium chloride and 0.035 weight percent potassium chloride. This mixture was applied to the TBC in a 2:1 weight ratio.

Mixture 3 was a pH 4 buffered water and sugar mixture prepared as follows. Mixture 1 was mixed with glucose, sucrose, and fructose to make a mixture having 1.9 weight percent fructose, 2.18 weight percent glucose, and 2.27 percent sucrose. This mixture was applied to the TBC in a 2:1 weight ratio.

Mixture 4 was a pH 4 buffered water, salt, and sugar mixture prepared as follows. To the pH 4 buffered water mixture sufficient sodium chloride and potassium chloride was added to give a pH 4 buffered water and salt mixture having 0.0125 weight percent sodium chloride and 0.035 weight percent potassium chloride. Additionally, sufficient glucose, sucrose, and fructose was added to make a mixture having 1.9 weight percent fructose, 2.18 weight percent glucose, and 2.27 percent sucrose. This mixture was applied to the TBC in a 2:1 weight ratio. The results are presented below in Table 1.

TABLE 1
Pair Choice Feeding Response

| | | mg consumed | Palatability |
|---|---|---|---|
| | | (Mean ± SEM) | Ratio |
| | | means followed by | Highest |
| | | different letter are | Consumption: |
| | Termite | significantly different | Lowest |
| Paired Choice | Species | (T-Test, p > 0.10) | Consumption |
| Mixture 1: | R. flavipes | 29.89 ± 7.01 a | 6.91 |
| Distilled Water | | 4.32 ± 2.96 b | |
| | | (p value = 0.082) | |
| Mixture 1: | R. virginicus | 14.93 ± 1.65 a | 40.35 |
| Distilled Water | | 0.37 ± 0.02 b | |
| | | (p value = 0.013) | |
| Mixture 2: | R. flavipes | 34.63 ± 4.84 a | 40.26 |
| Distilled Water | | 0.86 ± 0.25 b | |
| | | (p value = 0.095) | |
| Mixture2: | R. virginicus | 13.01 ± 4.77 a | 12.75 |
| Distilled Water | | 1.02 ± 0.73 a | |
| | | (p value = 0.114) | |
| Mixture 3: | R. flavipes | 25.80 ± 11.0 a | 43.00 |
| Distilled Water | | 0.60 ± 0.40 a | |
| | | (p value = 0.144) | |
| Mixture 3: | R. virginicus | 15.36 ± 1.90 a | 28.44 |
| Distilled Water | | 0.54 ± 0.34 b | |
| | | (p value = 0.022) | |
| Mixture 4: | R. flavipes | 20.59 ± 5.75 a | 50.22 |
| Distilled Water | | 0.41 ± 0.41 b | |
| | | (p value = 0.038) | |
| Mixture 4: | R. virginicus | 8.24 ± 2.22 a | 48.47 |
| Distilled Water | | 0.17 ± 0.06 b | |
| | | (p value = 0.035) | |

1. A method comprising contacting a termite bait with a mixture comprising water where said mixture is buffered to a pH of 1 to 6, with the proviso that said mixture is not a HC Mixture.

2. A method comprising contacting a termite bait with a mixture comprising water where said mixture is buffered to a pH of 1 to 6, with the proviso that said mixture is not a SSPB Mixture.

3. A method comprising contacting a termite bait with a mixture comprising water where said mixture is buffered to a pH of 1 to 6, with the proviso that said mixture is not a SSPI Mixture.

4. A method comprising contacting a termite bait with a mixture comprising water where said mixture is buffered to a pH of 1 to 6, with the proviso that said mixture is not a SSPN Mixture.

5. A method according to claim 1 wherein said termite bait comprises alpha-cellulose.

6. A method according to claim 2 wherein said termite bait comprises alpha-cellulose.

7. A method according to claim 3 wherein said termite bait comprises alpha-cellulose.

8. A method according to claim 4 wherein said termite bait comprises alpha-cellulose.

9. A method according to claim 5 wherein said mixture further comprises salt.

10. A method according to claim 6 wherein said mixture further comprises salt.

11. A method according to claim 7 wherein said mixture comprises salt.

12. A method according to claim 8 wherein said mixture further comprises salt.

13. A method according to claim 9 wherein said mixture further comprises sugar.

14. A method according to claim 10 wherein said mixture further comprises sugar.

15. A method according to claim 11 wherein said mixture further comprises sugar.

16. A method according to claim 12 wherein said mixture further comprises sugar.
